(19) United States
(12) Patent Application Publication
(10) Pub. No.: US 2023/0254149 A1
(43) Pub. Date: Aug. 10, 2023

(54) PROBABILISTIC DATA STRUCTURE FOR MANAGING TOKENS

(71) Applicant: Fastly, Inc., San Francisco, CA (US)

(72) Inventors: Janardhan Iyengar, Truckee, CA (US); Kazuho Oku, Tokyo (JP)

(21) Appl. No.: 18/165,135

(22) Filed: Feb. 6, 2023

Related U.S. Application Data
(60) Provisional application No. 63/307,468, filed on Feb. 7, 2022.

(51) Int. Cl. H04L 9/32

(52) U.S. Cl. CPC H04L 9/3213; H04L 9/3236; H04L 2209/76

(57) ABSTRACT

Various embodiments of the present disclosure relate to authentication and proxying using token management and packet communication techniques that allow end points to use a unique token to access content from the destination server without the destination server obtaining identifying information from the end point. In an example, a method comprises receiving a request for content from a client device, producing a hash value based on a current token in the request, determining whether the current token resides at a location associated with the hash value, and in response to determining that the current token does not reside at the location, attempting to authenticate the client device using the current token. Accordingly, each unique token can be tracked by the one or more proxy servers to ensure one-time use only from an authorized, authenticated end point.

### RELATED APPLICATIONS

This application claims the benefit of and priority to U.S. Patent Application No. 63/307,468, filed Feb. 7, 2022, entitled “Probabilistic Data Structure for Managing Tokens” which is hereby incorporated by reference in its entirety.

### TECHNICAL FIELD

Aspects of the disclosure are related to the field of computing and communications and, more particularly, to proxy server operations and authentication of users.

### BACKGROUND

Content delivery networks, edge cloud platforms, and other types of infrastructure services send and receive huge volumes of data. The data is typically sent and received between servers and end points over logical connections that are created and torn down dynamically as needed to handle packet flows over the connections. The servers and end points establish the connections with each other, typically in accordance with one or more of a variety of transport protocols such as the Transport Control Protocol (TCP) and, more recently, QUIC, which stands for Quick User Datagram Protocol Internet Connections.

An end point can establish such connections and receive data after being authorized by a server in various ways, such as with a key, one-time password, or the like. In networks involving many end points, authentication processes can require large amounts of processing power to verify a password provided by an end point is acceptable and associated with a user of the end point. Without authentication processes, access or content can inadvertently be provided to an unauthorized end point.

Various drawbacks to typical authentication arrangements result, however, when a server has to look up and verify several end points. First, the authenticating server expends valuable processing resources simply finding a location where a password exists to verify an end point. If the password is not commonly used, it may occupy valuable cache memory in the server potentially reducing the overall performance of the network. Further, if passwords are often reused, the server may perceive collisions in data schemes or fail to recognize overuse of a password and allow access where it should be prevented.

### Overview

The examples discussed herein provide authentication and identity masking, or proxying, between an end point (e.g., a computing device) and a destination server via one or more proxy servers. The authentication and proxying occur using enhanced methods of token management and packet communication that allows an end point to use a unique token to securely access content from the destination server without the destination server obtaining identifying information from the end point. Each unique token can be tracked and stored by the one or more proxy servers to ensure one-time use only from an authorized and authenticated end point.

One example implementation includes a method of operating a proxy server. The method comprises receiving a request for content from a client device, wherein the request includes a current token. The method further comprises producing a hash value based at least on the current token and determining whether the current token resides at a location associated with the hash value. In response to determining that the current token does not reside at the location, the method comprises attempting to authenticate the client device using the current token.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

While multiple embodiments are disclosed, still other embodiments of the present technology will become apparent to those skilled in the art from the following detailed description, which shows and describes illustrative embodiments of the invention. As will be realized, the technology is capable of modifications in various aspects, all without departing from the scope of the present invention. Accordingly, the drawings and detailed description are to be regarded as illustrative in nature and not restrictive.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modification's, and equivalents.

FIG. 1 illustrates an example operating environment for authentication and proxy server operations in an implementation.

FIG. 2 illustrates an example method of operating a proxy server for authentication management in an implementation.

FIG. 3 illustrates an exemplary operational sequence related to operating a proxy server in an implementation.

FIGS. 4A, 4B, and 4C illustrate example scenarios of authentication via token management processes used in an implementation.

FIG. 5 illustrates an example method related to authentication via token management in an implementation.

FIG. 6 illustrates an exemplary use case employing proxy server operations in an implementation.

FIG. 7 illustrates an exemplary operational sequence related to operating multiple proxy servers in an implementation.

FIG. 8 illustrates a computing system suitable for implementing the various operational environments, architectures, processes, scenarios, and sequences discussed below with respect to the Figures.

### DETAILED DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

Discussed herein are improvements to systems, devices, and methods of operating proxy servers capable of providing authentication and proxy services. For example, various implementations provide authentication and identity masking between an end point, such as a computing device or client device, and a destination server via one or more proxy servers. The authentication and masking occur using enhanced methods of token management and packet communication that allow an end point to use a unique token to securely access content from the destination server without the destination server obtaining identifying information from the end point. Each unique token can be tracked and stored by the one or more proxy servers to ensure one-time use only from an authorized and authenticated end point.

In an implementation, a method of operating a proxy server is provided. The method comprises receiving a request for content from a client device, wherein the request includes a current token. The method further comprises producing a hash value based at least on the current token and determining whether the current token resides at a location associated with the hash value. In response to determining that the current token does not reside at the location, the method comprises attempting to authenticate the client device using the current token.

In another example implementation, a computing device is provided. The computing device comprises one or more computer-readable storage media, one or more processors, and program instructions stored on the one or more computer-readable storage media that, when executed by the one or more processors, direct the computing device to perform various functions. In various instances, the program instructions direct the computing device to at least receive a request for content from a client device, produce a hash value based at least on the current token, determine whether the current token resides at a location associated with the hash value, and in response to determining that the current token does not reside at the location, attempt to authenticate the client device using the current token.

In yet another example implementation, another method of operating a proxy server is included. This method comprises obtaining a request for content from a client device, wherein the request comprises a destination server, a current token, and an IP address of the client device. The method also comprises forwarding, from a first proxy server, a portion of the request and an IP address of the first proxy server to a second proxy server, the portion of the request comprising the destination server and the current token. The method further comprises attempting to authenticate the client device at the second proxy server using the current token and in response to successfully authenticating the client device, forwarding, from the second proxy server, the portion of the request and an IP address of the second proxy server to the destination server. The method also comprises obtaining the content from the destination server.

Advantageously, a proxy server, and related methods, systems, and apparatuses, described herein can provide benefits such as enhanced security and anonymity for both an end point, the provider server of the end point, and a destination server. It may also provide benefits like hidden browsing while preventing unauthenticated use of private credentials and/or tokens, among other benefits. Because token management processes of various embodiments can utilize hash functions to ensure such security, authentication and verification of an end point can be performed more efficiently using probabilistic methods herein.

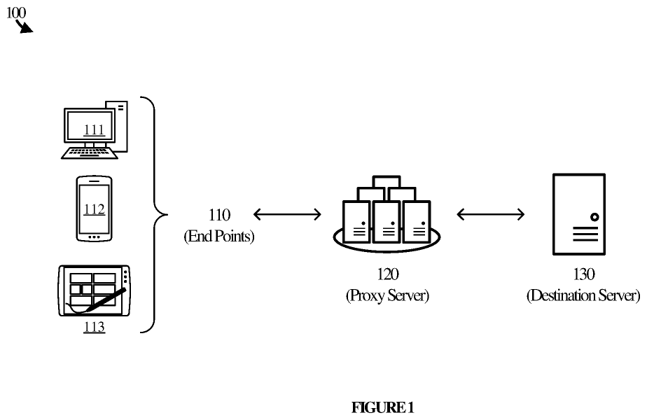

Referring now to the drawings, FIG. 1 illustrates operational environment 100 in an implementation. Operational environment 100 includes end points 110, proxy server 120, and destination server 130. End points 110 are representative of a client device or computing device, such as computer 111, phone 112, and/or tablet 113. In particular, end points 110 communicate and exchange information with proxy server 120 over a communication network. Proxy server 120 may coordinate with destination server 130 to provide content back to end points 110.

In operation, end points 110 request, via proxy server 120, content from a destination server 130. End points 110 may represent a client device, computing device, or other user device or system, as demonstrated by computer 111, phone 112, and tablet 113. The request may include a request for content, such as a webpage, file, application, or the like, contained at some other IP address or in another server, such as destination server 130. The request may also comprise information about the user, such as an IP address, an address/location of destination server 130, and authentication information, among other information. Authentication information can refer to a username and a password or some identifying information. For example, the authentication information can be represented by a token value. The token value is a unique identifier, a number of bits in length, that can be used to grant access (e.g., one-time access) to some content available on a server or database (destination server 130). The token value can be used to verify the authenticity of the user and/or the end point of end points 110 used for the request.

The request from end points 110 is communicated to proxy server 120 over a communication network. Proxy server 120 can be configured to authenticate end points 110, forward the request to another server, and/or anonymize the identity of the user of end points 110, among other functions. In various implementations, proxy server 120 represents a content delivery network, an edge cloud platform, or the like. Proxy server 120 may employ, for example, a hash algorithm configured to identify and authenticate a user of one of end points 110 to ensure that user can access the requested content. Proxy server 120 can perform the hash algorithm on a token to produce a hash value. The hash value is another unique identifier of a different length in bits from the token value that can be used to look up and store token values for verification purposes. More specifically, the hash value can correspond to a location wherein one or more tokens can be stored. In some instances, only one token may be stored at a single location; however, in other instances, more than one token can reside at a location associated with its calculated hash value due to a hash algorithms probabilistic nature. Following authentication, proxy server 120 can forward the request from end points 110, excluding the IP address of end points 110, to destination server 130.

In an example implementation, proxy server 120 can accept the token and authenticate the user of the end point if the token does not already exist at the location associated with the hash value (i.e., the token has not been used before). In such cases, proxy server 120 stores the token from the request at that location, obtains the content requested by the user from destination server 130, and sends the content to the end point. In another example implementation, proxy server 120 can reject the token and the user if the token does exist at the location associated with the hash value (i.e., the token has already been used at some previous time). Upon a finding of a used or existing token, proxy server 120 can request the user of the end point to attempt to re-authenticate and send another request. Further, proxy server 120 may take affirmative action and report and/or record re-use of the token. Recordation of re-use may allow proxy server 120 or a user to detect the presence of an issue with one or more tokens or threats to the server or end points 110. In yet another example implementation, proxy server 120 can determine that another token resides at the location associated with the hash value calculated for the token. Proxy server 120 can either accept and store the token at the location along with the other existing token, or it can reject the token and request the user of the end point to attempt to re-authenticate and send another request. Other scenarios or combinations may exist and be coordinated by proxy server 120 as well.

By using a hash algorithm to determine token authenticity, proxy server 120 not only ensures security of servers by preventing access from unauthenticated end points 110, but also it expedites authentication processes by eliminating various potential look-up and storage locations for tokens or passwords used to verify users. It may be appreciated that other end points or devices, besides end points 110, may instead be the threats to the servers. No matter the origin of the request, proxy server 120 can identify unauthenticated users based on results from the hash algorithm as described herein.

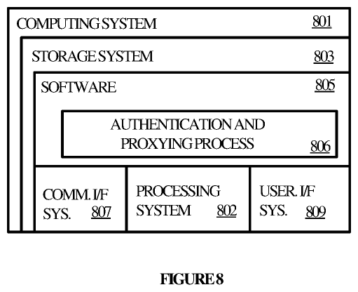

It may further be appreciated that proxy server 120 and destination server 130 can comprise various physical and/or virtual computing and communication elements suitable for implementing a variety of associated services and processes. For example, proxy server 120 may be implemented one or more computing systems, of which computing system 801 in FIG. 8 is representative. Proxy server 120 may be comprised of several servers and/or computing systems and make up one or more datacenters. Destination server 130 may also be representative of one or more servers, databases, websites, or any other computing systems.

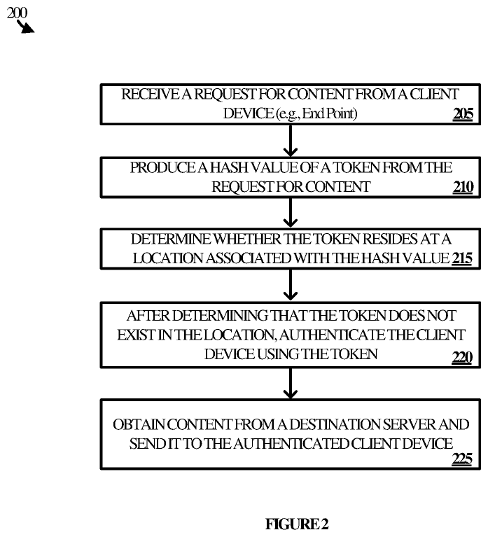

FIG. 2 illustrates an example method of operating a proxy server for authentication management in an implementation. Figure includes process 200, which may be implemented in program instructions in the context of any of the software applications, modules, components, or other such programming elements deployed in one or more servers or datacenters. The program instructions direct the underlying physical or virtual computing system or systems to operate as follows, referring parenthetically to the steps in FIG. 2. As an example, process 200 may be implemented in operating environment 100 of FIG. 1.

To begin, a proxy server receives a request for content from a client device (205). The client device may be represented by end points 110 of FIG. 1, and include devices or systems such as a computer, tablet, mobile device, or other computing system. The client device can communicate user information, an IP address, a destination, and a token for authentication, among other information, in the request for content. The request may indicate one or more types of information desired by the client device, such as a website, image, video, document, application, or other such objects, and where the information is sought from (e.g., destination server 130). The request is received via a connection established between the proxy server and the client device.

Next, the proxy server produces a hash value of the token from the request for content (210). The proxy server can employ a hash algorithm to produce the hash value which is configured to identify and authenticate the client device to ensure that the client device can access the requested content. The hash value can be a different set of numbers or letters of a different size than the token. The hash value of the token can correspond to a location wherein one or more tokens can be stored for look-up and authentication purposes. In some instances, no tokens may be stored at a location yet. A location may only store a single token; however, in other instances, more than one token can reside at a location associated with its calculated hash value.

After determining the hash value of the token and the associated location for the hash value, the proxy server determines whether the token resides at the location (215). The proxy server can index the location to find if the token is present at the location. If the token is not present at the location, the proxy server determines that the token does not exist or reside at the location. In other words, the proxy server determines that the token has not yet been used by a client device. Accordingly, the proxy server can store the token at the location to record use of the token and prevent future use of the same token. Then, the proxy server authenticates the client device using the provided token (220).

Following authentication, the proxy server can forward the request for content to the destination in the request. In various instances, the proxy server can hide the identity of the client device (e.g., IP address or other identifying information) when forwarding the request to the destination. The proxy server may provide an IP address of the proxy server itself instead of the client device to protect the client device and provide anonymity. The proxy server then obtains content from the destination, or a destination server, and sends it to the authenticated client device (225).

In another example, the proxy server can find that the token already exists at the location. If the token already exists, the proxy server can determine that the token is old (e.g., by identifying a timestamp of recordation at the location) or was previously used by the same or another client device, and it can reject the request for content. The proxy server can send a notification of rejection to the client device and request that the client device attempt to re-authenticate before content can be transmitted. In yet another example, the proxy server can find that a different token exists at the location. The proxy server can either store the current token at the same location along with the different token or it can overwrite the different token with the current token and authenticate the client device associated with the current token.

It may be appreciated that the locations corresponding to hash values can be located within various physical and/or virtual computing elements of proxy server. In other cases, locations or arrays may be stored remotely from proxy server in a database accessible by a proxy server, for instance.

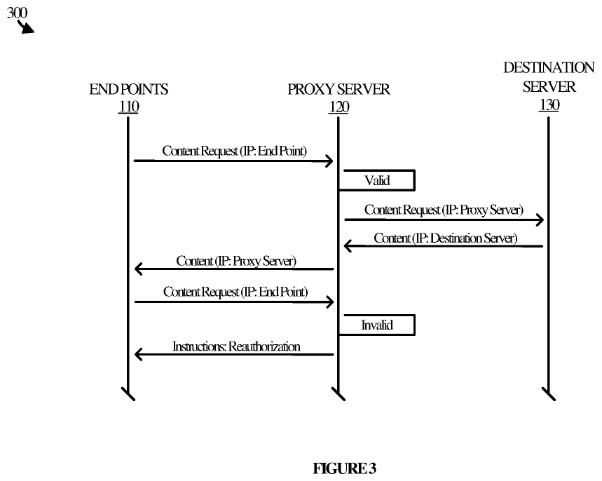

FIG. 3 illustrates an exemplary operational sequence related to operating a proxy server in an implementation. FIG. 3 includes operational sequence 300 in an implementation of process 200 with respect to the elements of FIG. 1. Like process 200, operational sequence 300 may be implemented in program instructions in the context of any of the software applications, modules, components, or other such programming elements deployed in each server. The program instructions direct the underlying physical or virtual computing system or systems to operate as follows.

In operation, end points 110 and proxy server 120 establish a communication network over which to send and receive information (e.g., packets, requests). End points 110, representative of computing or user devices such as computers, tablets, mobile phones, or the like, send a request for content to proxy server 120 via the communication network. The content request may include information like the content, or type of content, requested, the location of the content, an IP address of end points 110, a token for authentication to access the content, and the like.

Before proxy server 120 processes the content request, it validates the identity of end points 110. Proxy server 120 uses the token in the content request to verify that end points 110 is authenticated to perform a function (e.g., view, download, edit) on the content at the destination. Proxy server 120 generates a hash value of the token and finds a location associated with the hash value to determine whether the token has been used previously or not. In some cases, the token is not found at the location associated with the hash value. If the token does not exist at the location, proxy server 120 can validate and authenticate end points 110 to proceed. Proxy server 120 can also store the token at the location to prevent future, redundant use.

Proxy server 120 then forwards the content request to destination server 130 via a communication network between the two servers. Proxy server 120 may strip the IP address of end points 110 and instead send the content request with the IP address of proxy server 120. This ensures that the identity of end points 110 remains hidden.

Destination server 130 receives the content request, generates the content, and provides it to proxy server 120. The content from destination server 130 is sent from the IP address of destination server 130. Proxy server 120 can then forward the content to end points 110. Again, proxy server 120 can strip the IP address of destination server 130 and use the IP address of proxy server 120 when communicating information to end points 110.

In an example of a negative case, end points 110 send a content request to proxy server 120, but end points 110 is not authenticated to obtain the content requested. Proxy server 120 can produce a hash value of the token in the content request, find the location associated with the hash value, and determine that the token already exists at the location. In this example, the token has been previously recorded in the location signifying prior use of the token. Proxy server 120 sends instructions back to end points 110 to have end points 110 re-authenticate before requesting content again. To re-authenticate, end points 110 can attempt to authenticate using a different token when sending another content request.

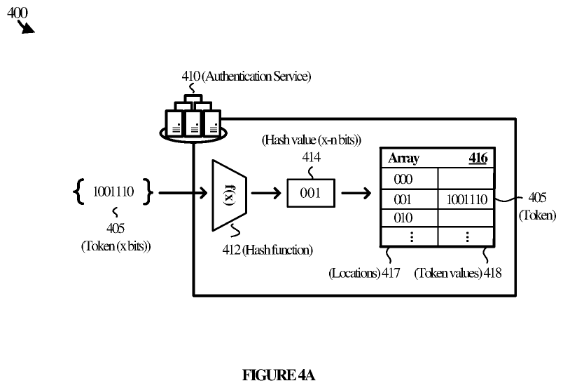

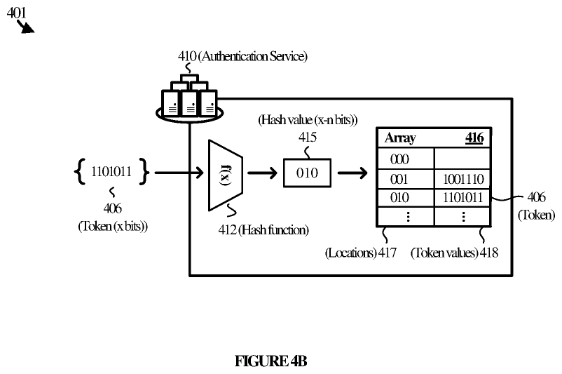

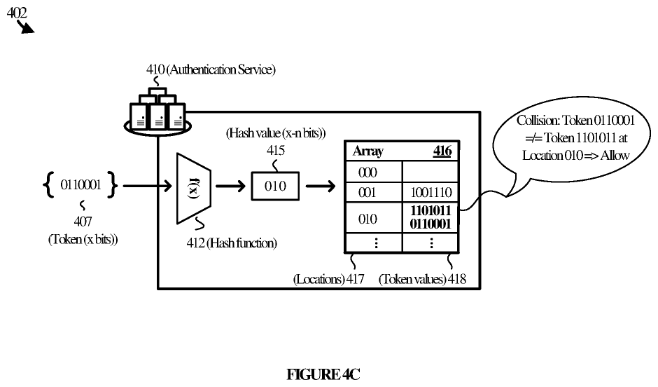

FIGS. 4A, 4B, and 4C illustrate example scenarios of authentication via token management processes used in an implementation. FIG. 4A includes operational scenario 400, which further includes token 405, authentication service 410, hash function 12, hash value 414, array 416, locations 417, and token values 418. FIG. 4B includes operational scenario 401, which demonstrates a different token (token 406) being applied within authentication service 410 at some time after operational scenario 400. FIG. 4C includes operational scenario 402, which demonstrates a similar scenario where token 407 is used in authentication service 410 at some time following both operational scenarios 400 and 401. In each example scenario, authentication service 410 can operate on a server, datacenter, or some computing system, and it can be configured to verify the authenticity of tokens.

In operational scenario 400, token 405 is presented to authentication service 410 for validation. Token 405 is an identifier, a number of bits in length (e.g., x bits), used to authenticate a client device by way of a one-time password, for example. In this scenario, token 405 is represented by “1001110.” Authentication service 410 receives token 405 and inputs it into hash function 412 to generate hash value 414. Hash value 414, like token 405, is another identifier that is some number of bits fewer than token 405 (e.g., x-n bits). By shortening the length of the string from “x” bits to “x-n” bits, authentication service 410 may use less processing power and less storage when storing hash value 414 in memory, a database, or the like. In operational scenario 400, hash value 414 is represented by “001.” Authentication service 410 can then store hash value 414 and token 405 in a data structure (array 416) to create a look-up table of both values. Array 416 includes at least two columns, locations 417 and token values 418, configured to store a corresponding hash value and token, respectively. For example, authentication service 410 can associate hash value 414 (“001”) with location “001” in locations 417, and it can store token 405 (“1001110”) in a corresponding field of token values 418 to map the two pieces of information together in array 416. Accordingly, location “001,” which may have been previously empty, now contains “1001110.” It may be appreciated that additional information may be stored in array 416, such as a timestamp of entry, a user or client device associated with the token, an IP address of the client device, and the like.

Next, in operational scenario 401, a different token, token 406, is presented to authentication service 410. Here, token 406 is represented by “1101011.” Authentication service 410 employs hash function 412 to calculate a different hash value 415. The hash value 415 of token 406 may now be represented by “010.” Authentication service 410 can then associate hash value 415 with a location of locations 417, such as “010,” and store token 406 in a field of token values 418 associated with location “010.”

It may be noted that because operational scenario 401 occurs at some time after operational scenario 400, location “001” still contains token “1001110” in array 416. As more tokens are used and validated by authentication service 410, fewer empty locations 417 in array 416 may exist. In some implementations, information in token values 418 can be deleted or overwritten after a specified amount of time. In other implementations, additional locations 417 can be added to allow space for more tokens. Alternatively, the fields in token values 418 may accept more than one token allowing overlap in hash values and tokens. It may be appreciated that any combination of aforementioned examples may be implemented.

Lastly, in operational scenario 402, another token 407 is presented to authentication service 410 following the input of tokens 405 and 406 in operational scenarios 400 and 401, respectively. Authentication service 410 uses hash function 412 to generate a hash value. This calculation results in the same hash value 415 as token 406 in operational scenario 401 (“010”). In this example implementation, authentication service 410 identifies that the location (“010”) associated with hash value 415 already contains token “1101011” from a previous entry. However, because the existing token “1101011” differs from token 407 (“0110001”), authentication service 410 may allow authentication using token 407. As a result, authentication service 410 can store token 407 (“0110001”) at location “010” in a corresponding field of token values 418.

In a further scenario, a token that already exists in array 416 may be input again into authentication 410 to attempt to gain illicit access to a server, database, or some computing system. When a token is already used, authentication service 410 can detect a duplicate value in token values 418 of array 416, and it can reject the token and require re-authentication from a user or end point. It may be appreciated that such redundant uses of tokens may be attempted from the same end point, or they may be executed by a different end point; however, the location or identity of the end point is germane as authentication service 410 is configured to block access unless a unique token is presented.

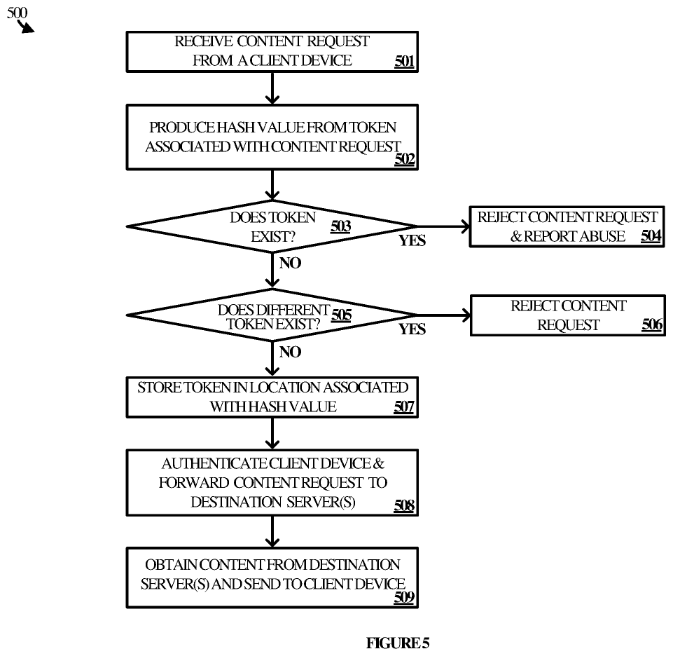

FIG. 5 illustrates an example method of operating a proxy server for authentication management in an implementation. Figure includes process 500, which may be implemented in program instructions in the context of any of the software applications, modules, components, or other such programming elements deployed in one or more servers or datacenters. The program instructions direct the underlying physical or virtual computing system or systems to operate as follows, referring parenthetically to the steps in FIG. 5. As an example, process 500 may be implemented in operating environment 100 of FIG. 1 or in any of operational scenarios 400-402 of FIGS. 4A, 4B, and/or 4C.

To begin, a proxy server receives a content request from a client device (501). The client device may be representative of any computing system or user device, such as a smart phone, tablet, computer, or the like, capable of communicating with the proxy server over a network. The content request may include information about the client device (e.g., IP address, username, and identifying information) and about the content (e.g., location, content type) to enable the proxy server to fulfill the request. The client device may further provide an authentication token for accessing the content. The proxy server may be representative of an edge network or content delivery network configured to verify the identity and authenticity of the client device and coordinate such content requests between the client device and a content server.

The proxy server next obtains the authentication token and produces a hash value from the token (502). The proxy server can employ one or more hash functions or algorithms to determine the hash value, and ultimately, whether a token has been used previously or not. In this example, the proxy server can map the hash value to a location in a data structure. Each location in the data structure can further be associated with one or more tokens. The proxy server can determine whether the token exists (503) in the data structure based on the location associated with the hash value. If the token does exist at the location, the proxy server can reject the content request and report abuse (i.e., invalid use of a token or redundant use of a token) (504). If the token does not exist at the location associated with the hash value, the proxy server must next determine whether a different token exists at that location (505). Again, if yes, the proxy server can reject the content request (506) due to a collision in the location. If the location is instead empty, the proxy server can store the token provided by the client device in the location associated with the hash value (507). In some instances, additional information may also be stored in the data structure along with the token, such as a timestamp of recordation of the token, the client device (or its IP address) that used the token, and the like.

The proxy server can then authenticate the client device and forward the content request to a destination server (508). The destination server may operate one or more websites, webpages, applications, databases, or some repository containing content. The proxy server can obtain the content requested and send it to the client device.

Referring back to step 505, some implementations allow the proxy server to map the token to a location in the data structure regardless of the presence of a different token. In such cases, the proxy server can store the token at the location and authenticate the client device. Referring back to both steps 504 and 506, the proxy server may further notify the client device of rejection and ask the client device to re-authenticate using a different token to retry the process.

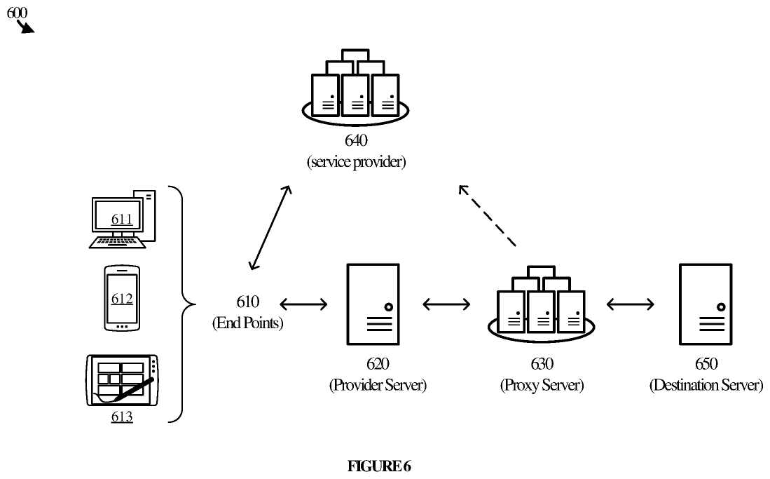

FIG. 6 illustrates an example use case employing dual-proxy operations in an implementation. FIG. 6 includes operating environment 600, which further includes end points 610, provider server 620, proxy server 630, service provider 640, and destination server 650. End points 610 are representative of any computing system or client device as demonstrated by examples computer 611, phone 612, and/or tablet 613. In particular, each component or device of operating environment 600 can communicate and exchange information with each other over a communication network.

In operation, proxy server 630 creates and provides a number of tokens to service provider 640. Service provider 640 can be configured to manage the tokens and distribute them to end points 610. Service provider 640 may distribute all of the tokens at one time for use by end points 610, it may distribute batches of tokens periodically, or it may distribute one token at a time as end points 610 request tokens. Each token allows an end point of end points 610 to gain access to content on a server, such as destination server 650.

In an implementation, one of end points 610 can send a content request and a token to provider server 620. The content request may comprise a content type (e.g., webpage, application, file), a content location (e.g., destination server 650), and identifying information about the end point, such as an IP address. Provider server 620 can be configured to receive the content request and serve as a first proxy between end points 610 and proxy server 630. Provider server 620 can remove the IP address of the end point from the content request and provide an updated content request using its own IP address to proxy server 630.

Proxy server 630 represents a content delivery network (CDN), an edge cloud platform, or the like, and can comprise various physical and/or virtual computing and communication elements suitable for implementing a variety of associated services and processes. Still referring to this example implementation, proxy server 630 can receive the updated request from provider server 620 and attempt to authenticate the end point before forwarding the content request to destination server 650. To authenticate the end point, proxy server 630 can employ a hash algorithm to produce a hash value of the token used in the content request. Proxy server 630 can then find a location associated with the hash value and perform a look-up function to determine if the token exists at the location. If proxy server 630 determines that the token does not exist at the location, it can authenticate the end point and store the token at that location. However, if proxy server 630 finds the token at the location, it can reject the content request and require the end point to send another content request with a different token.

In other instances, proxy server 630 may determine that the location already has a different token associated with it. Proxy server 630 considers this a collision and can perform one of several options. Proxy server 630 may store the token at the location in addition to the different token, it can reject the token and require re-authentication, or it can overwrite the different token and store the newer token there. In the instance where proxy server 630 overwrites the different token, proxy server 630 can inspect the timestamp of the different token, or some other information, to decide whether to overwrite or not. For example, proxy server 630 may determine that it distributed both tokens in the same batch to service provider 640. As such, proxy server 630 may not overwrite the different token so it can prevent re-use of the different token by end points 610, or some other computing system.

Proxy server 630 also acts as a second proxy to end points 610 and provider server 620. After authenticating the end point that sent the content request, proxy server 630 can replace the IP address of provider server 620 on the updated content request with the IP address of proxy server 630. Proxy server 630 can then send a further updated content request to destination server 650 to obtain the content.

Destination server 650 can represent a server, datacenter, database, or the like comprising data accessible by a CDN or computing system. Destination server 650 can receive the further updated content request and provide the requested content back to proxy server 630. Destination server 650 also replaces the IP address of proxy server 630 and sends the content with its own IP address. It follows that proxy server 630 continues to deliver the content to provider server 620, then provider server 620 delivers the content to the end point that requested the content. It may be appreciated that at the end of the content request and delivery process, at least proxy server 630 remains unaware of the IP address of the end point, and destination server 650 remains unaware of the IP address of both the end point and provider server 620. A dual-proxy environment, as illustrated in operating environment 600, can provide some level of anonymity as to who/what is requesting content and where the content is being obtained from.

At some point in time, the number of tokens distributed by service provider 640 may be fully used by end points 610 (i.e., causing an end point attempting to authenticate with a used token to be rejected) and/or reach a high percentage of collision (i.e., different tokens produce the same hash value resulting in overlapping storage locations at proxy server 630). When this occurs, end points 610 may no longer be authenticated efficiently or successfully and/or proxy server 630 may slow in speed due to large amounts of data being stored and searched. To alleviate this issue, proxy server 630 can distribute a number of new tokens to service provider 640, whereby only the number of new tokens can allow end points 610 to be authenticated. This may be accomplished by changing a key associated with the tokens, so that proxy server 630 can differentiate old tokens from new tokens, for example. Then, the previous number of tokens can be discontinued and/or removed from storage at proxy server 630. This may occur daily, weekly, or some other frequency depending on system requirements.

It may be appreciated that service provider 640 and proxy server 630 can operate together on the same server, database, or computing system. In other instances, service provider 640 and provider server 620 may operate together on the same server, database, or computing system. In any fashion, the elements of operating environment 600 can communicate with each other over a communication network and perform the functions described herein.

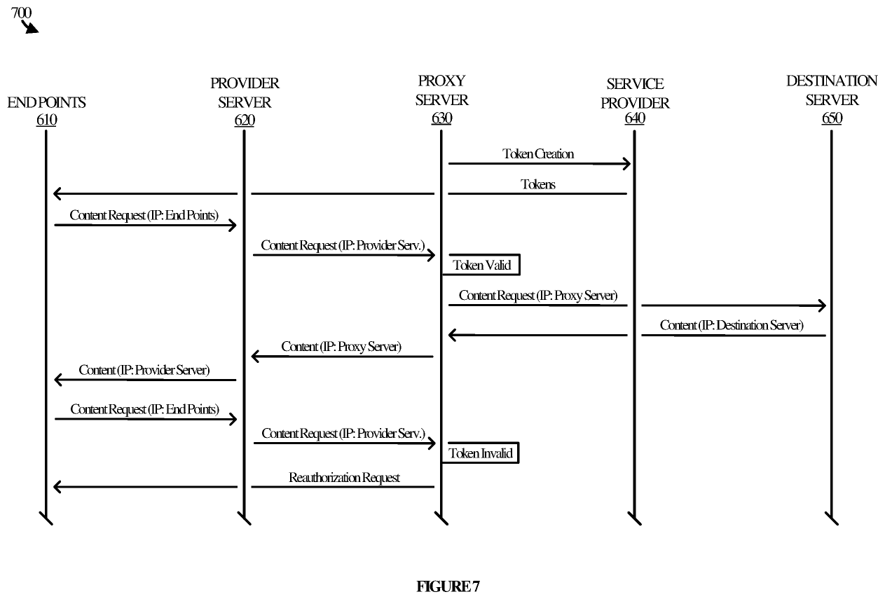

FIG. 7 illustrates an exemplary operational sequence related to operating multiple proxy servers in an implementation. FIG. 7 includes operational sequence 700 with reference to elements of operating environment 600 of FIG. 6. Operational sequence 700 may be implemented in program instructions in the context of any of the software applications, modules, components, or other such programming elements deployed in each server. The program instructions direct the underlying physical or virtual computing system or systems to operate as follows.

To begin, proxy server 630 creates a batch of tokens and provides the tokens to service provider 640. Proxy server 630 can maintain a record of the tokens created and at what date/time for authentication purposes. Service provider 640 distributes the batch of tokens to end points 610. Service provider 640 can distribute all of the tokens at once, or it can employ a periodic distribution method. Regardless, end points 610 can communicate with service provider 640 to access the tokens and use them in conjunction with content requests to obtain information on a destination server 650.

One of end points 610, such as computer 611, can send a content request to provider server 620. The content request can comprise a type of content requested, a DNS of destination server 650, a token, and other information about computer 611. Provider server 620 receives the content request and replaces the IP address of computer 611 with the IP address of provider server 620 before forwarding the content request to proxy server 630 to anonymize computer 611. Proxy server 630 receives the content request from provider server 620 without knowing it came from computer 611. Proxy server 630 performs a token authentication check on the token in the content request to determine if computer 611 can access the content it requested. To perform the token authentication check, proxy server 630 calculates a hash value of the token using a hash function, and it determines which location in a data structure the hash value is associated with. If proxy server 630 finds that the token does not exist at that location, proxy server 630 authenticates the content request from computer 611, stores the token value in the data structure at the location, and proceeds. Proxy server 630, like provider server 620, replaces the IP address of provider server 620 in the content request with the IP address of proxy server 630 then forwards the content request to destination server 650. Destination server 650 provides the content to proxy server using its own IP address in the packet of information. Subsequently, proxy server 630 forwards, using its IP address, the content to provider server 620, and provider server 620 delivers, using its IP address, the content to computer 611.

In another implementation, computer 611 can send a content request to provider server 620 using an invalid token. The invalid token may be the same token previously used by computer 611, or it can be a different token that was previously used by a different one of end points 610. When the content request reaches proxy server 630, proxy server 630 can attempt to authenticate computer 611 using the invalid token. Again, proxy server 630 produces a hash value of the token and finds the location associated with the hash value. In this example, however, proxy server 630 determines that the token already exists at the location and considers the token invalid. Proxy server 630 sends a reauthorization request to computer 611 to attempt authorization again.

FIG. 8 illustrates computing system 801 that is representative of any system or collection of systems in which the various processes, programs, services, and scenarios disclosed herein may be implemented. Examples of computing system 801 include, but are not limited to, server computers, web servers, cloud computing platforms, and data center equipment, as well as any other type of physical or virtual server machine, container, and any variation or combination thereof.

Computing system 801 may be implemented as a single apparatus, system, or device or may be implemented in a distributed manner as multiple apparatuses, systems, or devices. Computing system 801 includes, but is not limited to, processing system 802, storage system 803, software 805, communication interface system 807, and user interface system 809 (optional). Processing system 802 is operatively coupled with storage system 803, communication interface system 807, and user interface system 809.

Processing system 802 loads and executes software 805 from storage system 803. Software 805 includes and implements authentication and proxying process 806, which is representative of the token validation/authentication and proxying discussed with respect to the preceding Figures. When executed by processing system 802 to provide authentication and proxying, software 805 directs processing system 802 to operate as described herein for at least the various processes, operational scenarios, and sequences discussed in the foregoing implementations. Computing system 801 may optionally include additional devices, features, or functionality not discussed for purposes of brevity.

Referring still to FIG. 8, processing system 802 may comprise a micro-processor and other circuitry that retrieves and executes software 805 from storage system 803. Processing system 802 may be implemented within a single processing device but may also be distributed across multiple processing devices or sub-systems that cooperate in executing program instructions. Examples of processing system 802 include general purpose central processing units, graphical processing units, application specific processors, and logic devices, as well as any other type of processing device, combinations, or variations thereof.

Storage system 803 may comprise any computer readable storage media readable by processing system 802 and capable of storing software 805. Storage system 803 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 803 may also include computer readable communication media over which at least some of software 805 may be communicated internally or externally. Storage system 803 may be implemented as a single storage device but may also be implemented across multiple storage devices or sub-systems co-located or distributed relative to each other. Storage system 803 may comprise additional elements, such as a controller, capable of communicating with processing system 802 or possibly other systems.

Software 805 (including authentication and proxying process 806) may be implemented in program instructions and among other functions may, when executed by processing system 802, direct processing system 802 to operate as described with respect to the various operational scenarios, sequences, and processes illustrated herein. For example, software 805 may include program instructions for implementing an authentication and proxying process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 805 may include additional processes, programs, or components, such as operating system software, virtualization software, or other application software. Software 805 may also comprise firmware or some other form of machine-readable processing instructions executable by processing system 802.

In general, software 805 may, when loaded into processing system 802 and executed, transform a suitable apparatus, system, or device (of which computing system 801 is representative) overall from a general-purpose computing system into a special-purpose computing system customized to provide authentication and proxying. Indeed, encoding software 805 on storage system 803 may transform the physical structure of storage system 803. The specific transformation of the physical structure may depend on various factors in different implementations of this description. Examples of such factors may include, but are not limited to, the technology used to implement the storage media of storage system 803 and whether the computer-storage media are characterized as primary or secondary storage, as well as other factors.

For example, if the computer readable storage media are implemented as semiconductor-based memory, software 805 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 807 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 801 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A method of operating a proxy server, the method comprising:
receiving a request for content from a client device, wherein the request includes a current token;
producing a hash value based at least on the current token;
determining whether the current token resides at a location associated with the hash value; and
in response to determining that the current token does not reside at the location, attempting to authenticate the client device using the current token.

2. The method of claim 1, further comprising, in response to successfully attempting to authenticate the client device using the current token, obtaining the content from a destination server and sending the content to the client device.

3. The method of claim 1, further comprising, in response to unsuccessfully attempting to authenticate the client device using the current token, rejecting the request for content.

4. The method of claim 1, wherein the current token is considered to not reside at the location associated with the hash value if the location is empty.

5. The method of claim 4, wherein the current token is considered to not reside at the location associated with the hash value if the location is occupied by a different token.

6. The method of claim 5, further comprising overwriting the different token with the current token at the location associated with the hash value.

7. The method of claim 1, wherein the current token is considered to reside at the location associated with the hash value if the location is occupied by the current token.

8. The method of claim 7, further comprising, in response to determining that the current token resides at the location, rejecting the request for content.

9. The method of claim 2, further comprising serving as a proxy for the client device when obtaining the content from the destination server.

10. The method of claim 2, further comprising serving as a proxy for the destination server when sending the content to the client device.

11. A computing device, comprising:
one or more computer-readable storage media;
one or more processors; and
program instructions stored on the one or more computer-readable storage media that, when executed by the one or more processors, direct the computing device to at least:
receive a request for content from a client device, wherein the request includes a current token;
produce a hash value based at least on the current token;
determine whether the current token resides at a location associated with the hash value; and
in response to determining that the current token does not reside at the location, attempt to authenticate the client device using the current token.

12. The computing device of claim 11, wherein the program instructions further direct the one or more processors to, in response to a successful attempt to authenticate the client device using the current token, obtain the content from a destination server and send the content to the client device.

13. The computing device of claim 11, wherein the program instructions further direct the one or more processors to, in response to an unsuccessful attempt to authenticate the client device using the current token, reject the request for content.

14. The computing device of claim 11, wherein the current token is considered to not reside at the location associated with the hash value if the location is one among empty and occupied by a different token.

15. The computing device of claim 11, wherein the current token is considered to reside at the location associated with the hash value if the location is occupied by a token that is the current token.

16. The computing device of claim 11, wherein the program instructions further direct the one or more processors to serve as a proxy for one among the client device when obtaining the content from the destination server and the destination server when sending the content to the client device.

17. A method of operating a dual-proxy system, the method comprising:
obtaining a request for content from a client device, wherein the request comprises a destination server, a current token, and an IP address of the client device;
forwarding, from a first proxy server, a portion of the request and an IP address of the first proxy server to a second proxy server, the portion of the request comprising the destination server and the current token;
attempting to authenticate the client device at the second proxy server using the current token;
in response to successfully authenticating the client device, forwarding, from the second proxy server, the portion of the request and an IP address of the second proxy server to the destination server; and
obtaining the content from the destination server.

18. The method of claim 17, further comprising sending the content from the second proxy server to the first proxy server and sending the content from the first proxy server to the client device.

19. The method of claim 17, wherein attempting to authenticate the client device comprises generating a hash value using the current token and comparing the current token with a token at a location associated with the hash value, and wherein successfully authenticating the client device comprises determining that the current token is different than the token at the location associated with the hash value.

20. The method of claim 17, wherein at least one among the first proxy server and the second proxy server distributes the current token to the client device prior to the request.
